(19) United States
(12) Patent Application Publication
(10) Pub. No.: US 2015/0167449 A1
(43) Pub. Date: Jun. 18, 2015

(54) Well Cable Management

(71) Applicant: Paul F. Rodney, Spring, TX (US)

(72) Inventor: Paul F. Rodney, Spring, TX (US)

(73) Assignee: HALLIBURTON ENERGY SERVICES, INC., Houston, TX (US)

(21) Appl. No.: 13/977,892

(22) PCT Filed: Aug. 6, 2012
(86) PCT No.: PCT/US2012/049700

§ 371 Date: Jul. 1, 2013

(51) Int. Cl. E21B 47/12; E21B 23/01; E21B 47/06; H02G 9/06; E21B 17/20

(52) U.S. Cl. CPC E21B 47/12; H02G 9/06; E21B 17/20; E21B 47/06; E21B 47/065; E21B 23/01

(57) ABSTRACT

A wellbore communication system includes a first downhole positionable cable spool and a second downhole positionable cable spool. A downhole relay receives and repeats power and/or data signals between cables of the first and second cable spools.

### BACKGROUND

The present disclosure relates to communicating data and/or power in a well.

Many well devices used in drilling, completing and reworking a well require power and/or communicate data with other devices in the well and on the surface. Data and/or power can be communicated over a cable into the well. However, the cable, if not maintained taught, can be subject to slacking, which may cause the cable to contact and wear on components in the well. Similarly, the cable can tangle and knot or hang-up in the well. These problems are particularly acute when the well deviates from vertical, because the cable must traverse a bend or span a horizontal portion of the well.

### DESCRIPTION OF DRAWINGS

FIG. 1 is a schematic side cross-sectional view of a well incorporating a well string and utilizing a cable management system.

FIG. 2A is a detail side cross-sectional view of a well depicting an example spool of a cable management system. FIG. 2B is a detail side cross-sectional view of the cable brake of spool of FIG. 2A.

FIG. 3 is a detail side cross-sectional view of a well depicting the example spool of FIG. 2A received in an example interface sub of the well string.

FIG. 4 is a schematic of an electronics and controller package.

FIG. 5 is a detail side cross-sectional view of a well string depicting an example surface communication sub.

Like reference symbols in the various drawings indicate like elements.

### DETAILED DESCRIPTION

An example of a cable management system constructed in accordance with the concepts described herein incorporates one or more spools that pay out cable from one location, within or outside of a well, to another location within a well in a controlled fashion. In doing so, the cable management system facilitates using cable to communicate data and/or power with well devices downhole. For example, the one or more spools can be utilized to pay out cable to devices in a well string as the string is extended into the well. Unlike a traditional wireline system, the cable does not support the devices in the well. In certain instances, one or more of the spools can be docked in a tubular, such as the well string, to be attached to move with the tubular. A segment of cable can be paid out from one spool while data and/or power is communicated to a downhole device over the cable. The spool can be docked and the segment of cable communicably coupled to a segment of cable of a second spool. Thereafter, the second spool can be used to pay out cable to the first spool while data and/or power is communicated over the cable. If needed, the second spool can be docked, and a third spool used to pay out cable to the second while data and/or power is communicated over the cable, and so on. The spools include an interface sub to condition and/or amplify the data, and in certain instances, add data from additional sources to the data being transmitted. The cable management system enables use of multiple shorter segments of cable to span a distance, rather than a single long segment of cable spanning the entire distance. In certain instances, the multiple shorter spans help prevent or eliminate problems such as excess slacking and tangling of the cable.

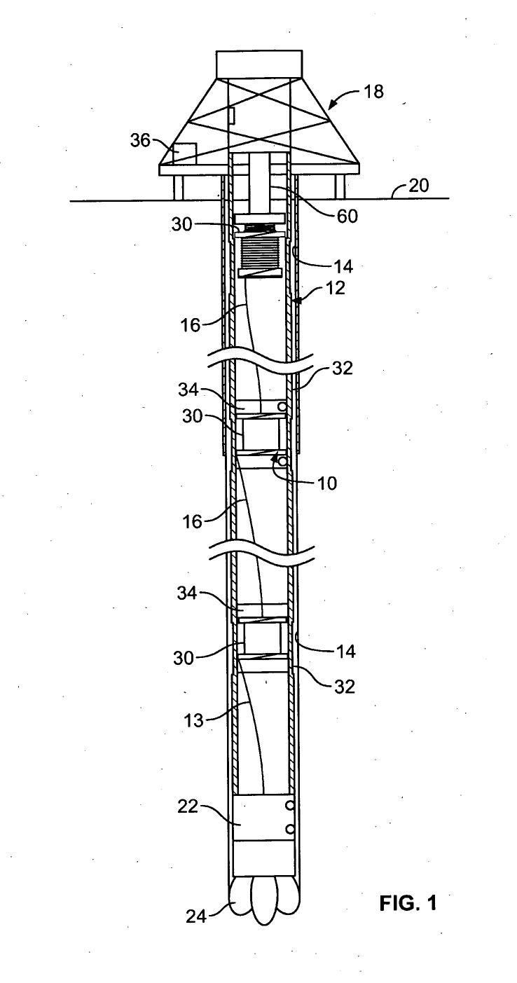

Referring first to FIG. 1, an example cable management system 10 is shown in a drilling context, incorporated into a tubular well string 12. In FIG. 1, the well string 12 is depicted as a drill string used to drill a wellbore 14 of a well. The concepts discussed herein, however, are not limited to use in drilling or with drill string, however, and could be used in connection with other types of well strings and well operations, including well treatment (e.g., fracturing, gravel packing, acidizing and/or other treatments via a well treatment string), production (via a production string), workover (via a work string) and/or other types of operations.

The well string 12 extends downhole into the wellbore 14 from a drilling rig 18 at a terranean surface 20. The well string 12 is constructed of multiple joints of tubing and other components. In particular, because it is a drill string, the well string 12 depicted in FIG. 1 has a drill bit 24 coupled to a drilling motor (e.g., a mud motor, electric motor and/or other type of motor) to drive the drill bit 24 in drilling through the Earth. The well string 12 is lengthened to allow it to extend deeper into the Earth by adding additional joints of tubing and/or other components. The tubing and/or other components are added to the well string 12 at the drilling rig 18, and can be coupled together at a box and pin threaded connection. In other instances, the well string 12 can be partially or wholly constructed of coiled tubing that, rather than being made up of multiple lengths of relatively short tubing (typically 31 ft/9.6 m), is a single continuous length. The coiled tubing is uncoiled from a spool at the surface 20 as it is extended deeper into the Earth.

The cable management system 10 manages a cable 16 that runs through the center bore of the well string 12. The cable 16 extends from a location proximate the surface 20 to one or more devices in the wellbore 14 (hereinafter the “communicated devices”) and communicates power and/or data between the communicated devices and the location proximate the surface 20. Target sub 22, carried in the well string 12, is an example communicated device with which the cable 16 communicates power and/or data. In certain instances, as will be discussed in more detail below, the cable 16 additionally or alternatively communicates power and/or data with one or more other communicated devices in the well string 12 and/or wellbore 14.

The data can be in the form of communications to and/or from the devices. Some examples of communications can include control communications (e.g., a signal to actuate or otherwise affect the operation of a device), information about the status of a device, data output from a device (e.g., data and signals output from a sensor), and/or other types of communications. The power can be used to power the communicated device and/or other elements in the well. In certain instances, data and power can be communicated concurrently. Some examples of the communicated devices include devices that collect data about the well string 12, the fluids within the bore of well string 12, the fluids outside of the well string 12 (including those in the annulus between the well string 12 and the wall of the wellbore 14, as well as those in the surrounding formations), formation evaluation sensors, drilling mechanics sensors, surveying sensors, accelerometers, magnetometers, pressure sensors, temperature sensors, and/or other devices. The communicated devices can include devices controlled by the communications including valves and ports (e.g., actuable to open/close and/or otherwise adjust), seals (e.g., actuable to seal/not seal), actuable well string 12 centralizing or stabilizing mechanisms (e.g., actuable to extend/retract from the well string 12) and/or other devices.

In certain instances, the target sub 22 includes measurement-while-drilling (MWD) communicated devices such as one or more sensors for sensing conditions in the wellbore 14 (e.g., pressure, temperature and/or other conditions), one or more accelerometers for determining the trajectory of the well string 12, one or more magnetometers for determining the orientation of the well string 12 relative to the Earth's magnetic field and/or other devices. The MWD devices can be controlled via the cable 16, and data can be communicated, for example between the MWD devices and the surface 20 and/or another location, via the cable 16. In certain instances, the target sub 22 may alternatively or additionally include logging-while-drilling (LWD) communicated devices such as one or more sensors for sensing conditions of the formation (e.g., resistivity, porosity, sonic velocity, density via gamma ray and/or others) and/or other devices. The LWD devices can be controlled via the cable 16, and data can be communicated, for example between the LWD devices and the surface 20 and/or another location, via the cable 16.

The cable 16 can be an electric conductor or wire, fiber optic or other type of cable for communicating data and/or power. The cable 16 can include one or more wires and/or optical fibers housed in a protective sheath, and can define one or multiple parallel communication paths. The wires and/or optical fibers can be arranged in one or multiple configurations, including twisted-pair, coaxial, and/or other arrangements. The wires and/or optical fibers can be insulated or uninsulated within the sheath. The optical fibers can include single and/or multi-mode optical fibers. In certain instances, single mode optical fibers can be used over multi-mode optical fibers to provide a reduced diameter cable 16. The protective sheath, in certain instances, can be of a high tensile strength to provide the primary tensile strength of the cable 16. In certain instances, the protective sheath is a high-strength toughed fluoropolymer (HSTF) and/or other material.

The ends of the cable 16 and/or segments of the cable terminate in connectors adapted to attach and be retained to other components (e.g., by mating detent and slot and/or otherwise). The cable ends may be designed to prevent stress accumulation between the connector and the filaments of the cable 16, for example, by tapering the transition between the connector and connector, including an armor extending from the connector a specified length along the filaments of the cable 16, and/or otherwise. In instances where the cable 16 includes optical fibers, the connector may include an optical/electrical interface, for example a photo diode, photo transistor and/or otherwise be connected to electrical contacts of the connector. In certain instances, the connector can include other components such as, signal conditioning electronics, power supply (e.g., battery), and/or other functions.

The cable management system 10 includes one or more bobbins or spools 30 (three shown) on which the cable 16 is carried. The spools 30 are used to carry the cable 16 into the wellbore 14, and maintain the cable 16 in an organized fashion while the cable 16 is paid out to the target sub 22 and to other spools 30 as the well string 12 moves downhole through the wellbore 14. In certain instances, one segment of cable 16 is wound on one spool 30; however, in other instances, multiple segments can be wound on a single spool 30 to be paid out in parallel or sequentially.

When the system is fully deployed, a segment of the cable 16 spans between the target sub 22 and the downhole -most spool 30 and, if using multiple spools 30 as in FIG. 1, additional segments span between the intermediate and uphole most spools 30. An end of cable 16 is communicably coupled to the target sub 22 to communicate power and/or data with the devices thereof, and is also mechanically attached, directly or indirectly, to the target sub 22 such that as the target sub 22 is moved away from the spool 30 (or the spool 30 moved away from the target sub 22) the cable 16 is drawn off the spool 30. The spools 30 can be adapted to maintain tension on the cable 16 as it is paid out, for example, to prevent the cable 16 from prematurely uncoiling from the spool 30. The number of spools 30 used can depend on a number of factors, including the distance to be spanned by the cable 16, the desired length of the cable segments carried on the spools 30, the desired length of the spans between the spools 30 and between the downhole most spool 30 and the target sub 22, and/or other factors. In certain instances, the spacing requirements of sensors in the string 12 (including sensors in the interface sub 32, discussed below) and/or sensors in the spools 30 (also discussed below) can influence the distance spanned by the cable 16. Using a greater number of spools 30 over a given distance facilitates shorter segments of cable 16 between the spools 30 than if fewer spools 30 are used. In certain instances, shorter segments of cable 16 are less prone to slacking and tangling. In certain instances, it is desirable to use a greater number of spools for spanning longer distances than shorter distances. Of note, although described and shown with the cable 16 being paid off from the spools 30 toward the downhole direction, the system could be arranged oppositely with one or more spools 30 paying off cable 16 toward the uphole direction.

The spools 30 can be adapted to interface communications of data and/or power with the segment of cable 16 carried thereon. In certain instances, the spools 30 can be adapted to interface communications of data and/or power from one segment of cable 16 to another to enable use of multiple segments of cable 16 to span between the target sub 22 and the location proximate the surface 20. For example, a spool 30 carrying a segment of cable 16 can interface with, and communicate power and/or data, with a segment of cable 16 carried on another spool 30. In FIG. 1, the downhole most spool 30 communicates power and/or data with its segment of cable 16 and with the segment of cable 16 carried by the intermediate spool 30. The intermediate spool 30 communicates power and/or data with its segment of cable 16 and the segment of cable 16 carried by the uphole most spool 30. In certain instances, one or more of the spools 30 can include one or more communicated devices with which the cable 16 communicates power and/or data, such as the communicated devices described above.

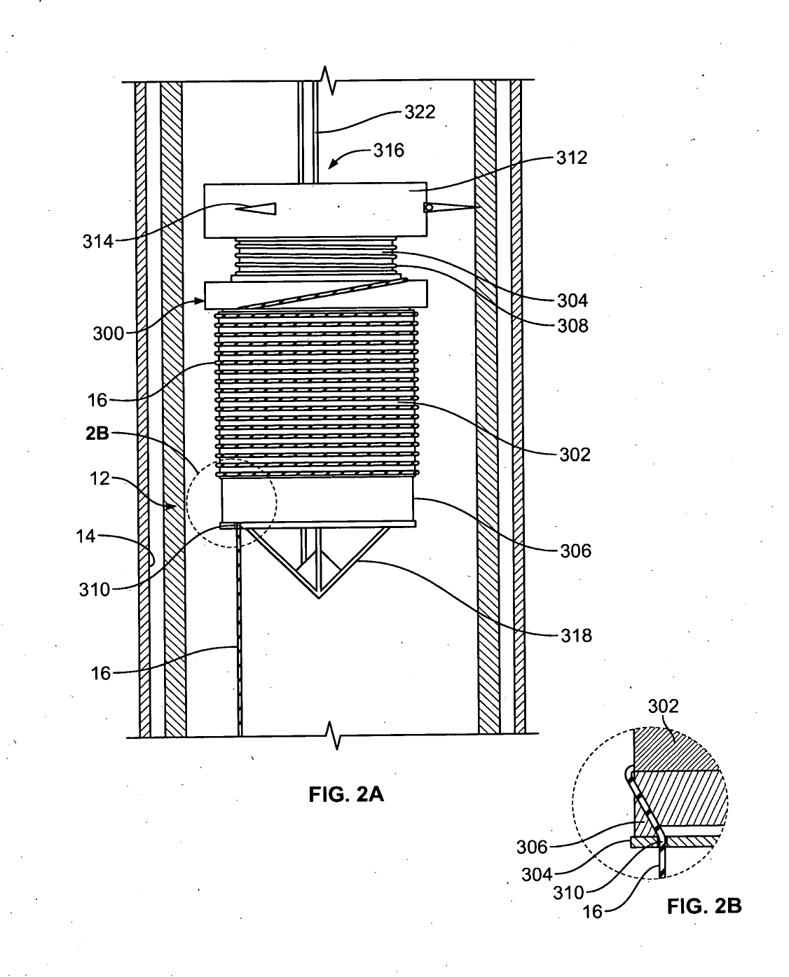

The spools 30 can include a gripping mechanism 34 (e.g., a collet, dog, slips and/or other gripping mechanism) configured to grip the inside of tubing, such as the inside of well string 12, and support the spool 30 relative to the tubing. When gripped to the tubing, the spool 30 is carried to move with the tubing. The gripping mechanism 34 can be biased to allow the spool 30 to move uphole relative to the tubing, and to grip and support the spool 30 against movement, relative to the tubing, downhole. In certain instances, the gripping mechanism 34 can be automated (e.g., by motor, hydraulics, and/or otherwise) to crawl through the inside of tubing, such that the spool 30 can be actuated to crawl uphole or downhole through tubing to maintain the spool 30 depth as the tubing is extended deeper into the well. The gripping mechanism 34 can be actuated to crawl through the tubing in one or a number of different manners, including via radio frequency communication, acoustic communication, infrared (IR) communication, wired communication, optical communication (e.g., fiber optic and/or other), communication over an inductive coupling, pressure signal and/or other mode of communication. In certain instances, the gripping mechanism 34 can be actuated to crawl via communications over cable 16. FIG. 2, discussed below, shows an example spool 300 that can be used as spool 30.

In certain instances, the cable management system 10 can include one or more interface subs 32 (two shown). The interface sub 32 is configured to receive a spool 30 to dock therein, and when docked, be carried with the spool 30 to move with spool 30. The interface sub 32 can interface with the gripping mechanism 34 of the spool 30, for example having an internal profile that engages the gripping mechanism 34 to facilitate docking the spool 30.

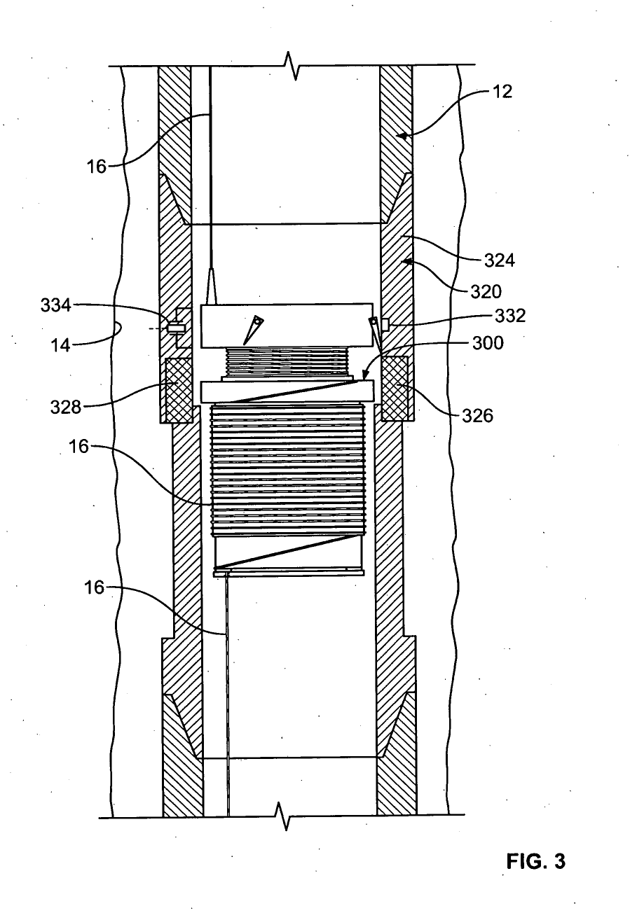

In certain instances, one or more of the interface subs 32 can include one or more communicated devices with which the cable 16 communicates power and/or data, such as those described above. One or more of the interface subs 32 can include additional functions, including a repeater that is configured to repeat and, in certain instances, condition (e.g., reformat, remove noise, amplify and/or other conditioning) the data communicated by the cable 16. For example, data and/or power communicated on a segment of cable 16 of a spool 30 docked in an interface sub 32 is communicated with the interface sub 32, then repeated and/or conditioned and output to the next segment of cable 16 coupled to the spool 30 via a connector. The interface sub 32 can include a power supply (e.g., battery) for supplying power to the repeating and/or conditioning circuits, for supplying power to the spool 30, for supplying power communicated devices and/or other devices of the interface sub 32, and/or for supplying power to another component of the well string 12 apart from the interface sub. In certain instances, the interface sub 32 can communicate power and/or data with the segment of the cable 16, for example, via the spool 30 docked therein. FIG. 3 shows an example interface sub 320 that can be used as interface sub 32.

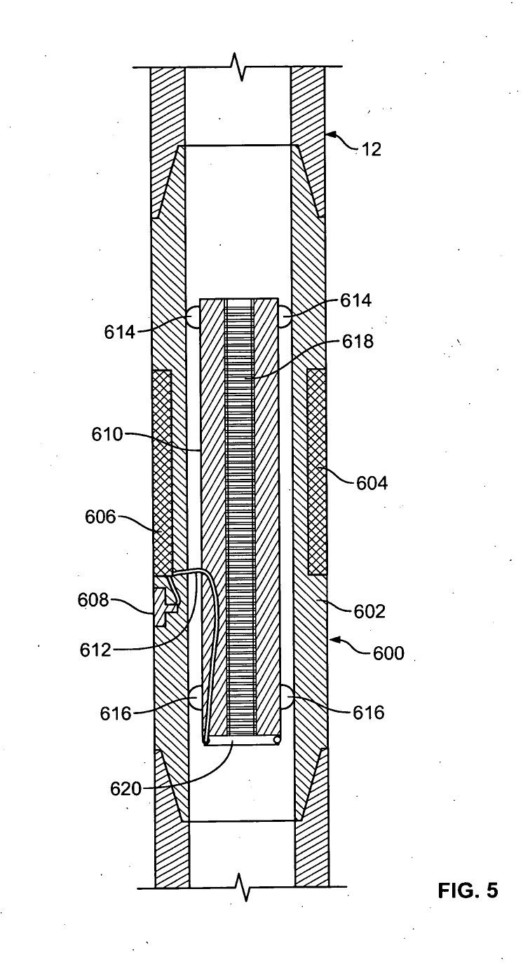

The uphole most spool 30 can communicate outside of the well string 12, for example with external device 36 outside of the well string 12 at the surface 20, via an additional segment of cable 16, a wireless link, and/or in another manner. In certain instances, the well string 12 can be provided with a surface communication sub 60 installed at or near the top of the well string 12 to facilitate this communication. In certain instances, it may be desirable to configure the surface communication sub 60 as a saver sub, i.e., a tubing adapted to couple between the top drive of rig 18 and the remainder of the well string 12, and below which tubing and components are added to the well string 12 to save wear and tear on the coupling of the top drive. The surface communication sub 60 can include a communications coupling for communicating with the uphole most spool 30, and a transmitter/receiver for communicating with the external device 36, such that communications are relayed between the external device 36 and the uphole most spool 30. In certain instances, the coupling can communicate with the uphole most spool 30 wirelessly (e.g., via radio frequency (RF), infrared (IR), acoustic, inductive, magnetic and/or otherwise). In certain instances, the transmitter/receiver can communicate with the external device 36 (e.g., via radio frequency (RF), infrared (IR), acoustic, inductive and/or otherwise). The external device 36 can be one or a number of different devices. Some examples of external devices 36 can include a control panel for a human operator, a data storage device, a controller and/or other devices. FIG. 5, discussed below, shows an example surface communication sub 600 that can be used as surface communication sub 60.

As mentioned above, FIG. 2A shows an example spool 300 that can be used as spool 30. The spool 300 includes a tubular outer drum 302 mounted on a tubular inner drum 304. A segment of the cable 16 is coiled around the outer drum 302 and extends through an aperture 310 (FIG. 2B) in the lower end of the inner drum 304. The aperture 310 is positioned and/or oriented to prevent the cable 16 from exceeding its critical bending radius, beyond which the cable 16 will be damaged or break, as the cable is paid off the spool 300. The outer drum 302 is biased toward and traps the cable 16 against a brake material 306 at the downhole end of the inner drum 304 by a helical spring 308. In the configuration shown, the brake material 306 is annular having a female conical surface that abuts a corresponding male conical surface of the drum 302. In certain instances, the brake material 306 can be a carboxilated nitrile. The cable 16 trapped between the outer drum 302 and the brake material 306 provides a small amount of resistance to maintain the cable 16 from prematurely unwinding from the outer drum 302. As tension is applied to the cable 16 from downhole of the spool 300, the cable 16 draws the outer drum 302 into stronger engagement with the brake material 306. This stronger engagement, in turn, traps the cable 16 more strongly between the outer drum 302 and brake material 306 and provides an increased amount of resistance to paying out the cable 16 from the spool 300. In certain instances, the resistance limits the rate at which the cable 16 is paid off the spool 300 and prevents the cable 16 from being deployed too rapidly.

The helical spring 308, affixed both to the outer drum 302 and inner drum 304, also limits the amount in which the outer drum 302 can rotate relative to the inner drum 304. As the helical spring 308 coils tighter, it generates a torque that counters the torque applied by the cable 16 as it pays off the bottom of the outer drum 302. The counter torque generated by the helical spring 308 tends to maintain the cable 16 in tension as the tension in the cable 16 itself changes (e.g., from flexure of the cable 16 and movement of the string).

The upper end of the inner drum 304 includes a housing 312 with a female receptacle for communicably coupling and attaching to the male connector of the cable 16. In other instances, the cable 16 can have a connector with a female receptacle and the housing 312 a male connector. The housing 312 includes electronics for interfacing the communication of power and/or data from one segment of the cable 16 to the segment of the cable 16 carried on the spool 300. The upper end of the outer drum 302 includes a notch through which the cable 16 passes and couples to the housing 312 of the inner drum 304. FIG. 2A also shows radially extendable/retractable dogs 314 (e.g. extendable/retractable by motor, spring, hydraulically and/or otherwise), adapted to engage the interior of tubing (e.g., well string 12) and support the spool 300 relative to the tubing. The dogs 314 are arranged around the circumference of the housing 312. Three equally spaced dogs 314 are shown, however, fewer or more can be provided. The dogs 314 of FIG. 2A are configured to engage the interior of tubing to prevent the spool 300 from moving downhole relative to the tubing. The dogs 314 can be of a type that engage and grips a profile in the well string and/or can be of a type that engage and grips the well string apart from a profile (e.g., slips and/or the like).

FIG. 2A also shows a lifting tool 316 for carrying the spool 300 up through the bore of a well string (e.g., well string 12). The tool 316 has an articulating assembly 318 that folds upon entering the central bore of the spool 300. Upon emerging from the downhole end of the spool 300, the assembly 318 opens automatically (e.g., by motor, spring and/or otherwise) or manually (e.g., by manually operated linkage and/or otherwise), engaging the downhole end of the spool 300. When opened, the tool 316 can lift the spool 300 via a long handle 322 attached to the articulated assembly 318.

FIG. 3 shows an example interface sub 320 that can be used as interface sub 32. The interface sub 320 is shown coupled to a spool 300. The interface sub 320 includes a tubing 324 adapted to couple into the well string 12 (e.g., threadingly and/or otherwise). The interior of the tubing 324 is sized to and may also include a profile to engage with the gripping mechanism (e.g., dogs 314) of the spool (e.g., spool 30, 300) to enable the spool to be docked in and carried in the interface sub 320. The interface sub 320 includes a battery 326 coupled to an electronics module 328. The interface sub 320 also includes a communications coupling 332 (e.g., wired and/or wireless) for communicating data and/or power with components of the spool 300, such that the interface sub 320 can communicate with the cable 16 via the spool 300. The communications coupling 332 is coupled to the electronics module 328 and the battery 326. The electronics module 328 can include a repeater that is configured to condition (e.g., reformat, remove noise, amplify and/or other conditioning) the communications from the cable 16. The electronics module 328, in certain instances, can be configured to apply power from the battery 326 to amplify the communications from the cable 16. In certain instances, the interface sub 320 can include one or more communicated devices 334 (shown as a transducer), such as those described above, with which the cable 16 communicates data and/or power. Data and/or power can be communicated with the communicated devices 334 to the surface and/or to other devices downhole.

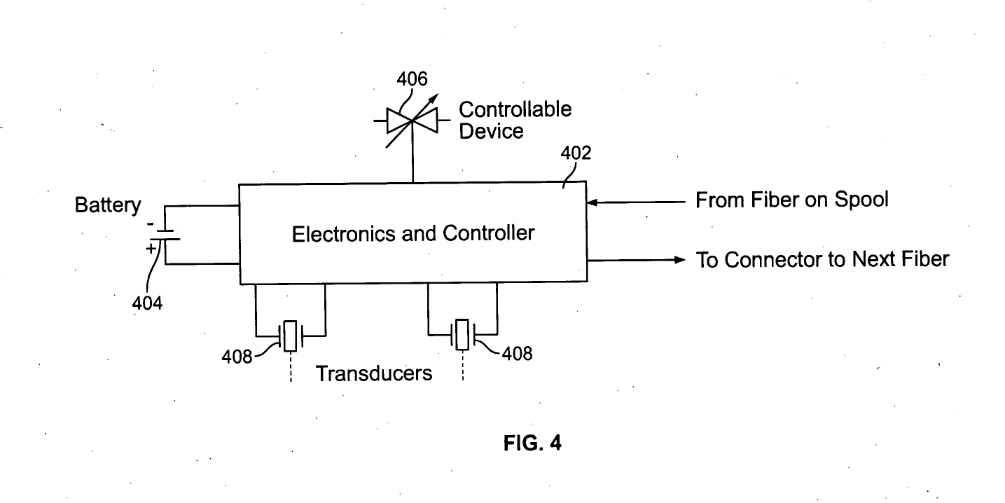

FIG. 4 shows an example electronics and controller package 402 that can be provided in the spools 300. The electronics and controller package 402 can be provided with a battery 404 coupled to the package 402. The package 402 is configured to communicate (e.g., wired and/or wirelessly) with the cable carried on the spool and with another cable coupled to the spool. The electronics and controller package 402 can include a repeater that is configured to condition (e.g., reformat, remove noise, amplify and/or other conditioning) the communications from the cable 16. The package 402, in certain instances, can be configured to apply power from the battery 404 to amplify the communications from the cable 16. In certain instances, the electronics and controller package 402 can include one or more communicated devices 408 (shown as transducers), such as those described above, with which the cable 16 communicates data and/or power. Data and/or power can be communicated with the communicated devices 408 to the surface and/or to other devices downhole.

FIG. 5 shows an example surface communication sub 600 that can be used as surface communication sub 60. The surface communication sub 600 includes a tubing 602 adapted to couple into the well string 12 (e.g., threadingly and/or otherwise), and in certain instances to couple between a top drive of the rig 18 (FIG. 1) and the remainder of the well string 12. In certain instances, the surface communication sub 600 is configured as a saver sub. The surface communication sub 600 includes a battery 604 coupled to power a wireless transmitter/receiver 608 (e.g., radio frequency (RF), infrared (IR), acoustic, inductive and/or other transmitter/receiver) and its associated electronics 606. As shown in FIG. 5, the battery 604, transmitter/receiver 608 and associated electronics 606 are mounted in a recess in the outer wall of the tubing 602, such that the outside diameter of the surface communication sub 600 is substantially uniform. The transmitter/receiver 608 and its associated electronics 606 enable communication with a device external to the well string, such as external device 36 (FIG. 1).

The surface communication sub 600 includes a coupler tube 610 carried in the central bore of the tubing 602 and in communication with the battery 604, transmitter/receiver 608 an associated electronics 606 via a flexible cable 612. A bearing 614, biased radially outward for example by a spring and/or otherwise, is provided on the coupler tube 610 to centralize the coupler tube 610 in the bore of the tubing 602. The surface communication sub 600 includes one or more motor driven pinions 616 that engage the exterior of the coupler tube 610 (e.g., by engaging a rack 618 or other structure on the exterior of the coupler tube 610) and can be actuated to drive the coupler tubing 610 up and down along the longitudinal axis of the surface communication sub 600.

The coupler tube 610 includes an inductive communications coupling 620 about its lower (downhole) end for communicating data and/or power with a corresponding inductive coupling of a spool (e.g., spool 30, FIG. 1) and/or an interface sub (e.g., interface sub 32, FIG. 1). The communications coupling 620 in turn communicates via the flexible cable 612 with the battery 604, transmitter/receiver 608 and associated electronics 606. The inductive coupling 620 can be moved into and out of proximity with the spool, to inductively communicate or break communication, by actuating the motor driven pinions 616. Communications to and from the spool via the communications coupling 620 are relayed to the external device (e.g., external device 36 of FIG. 1) via the transmitter/receiver 608. Power from the battery 604 and/or another source is communicated to the spool via the communications coupling 620.

Referring back to FIG. 1, in operation, a segment of cable 13 is coupled to a device, for example target sub 22, in the well string 12 and a spool 30 carrying the segment of cable 13 is supported in the bore of the well string 12. The gripping mechanism 34 can be used to support the spool in the well string 12. Communication of power and/or data is established with the spool 30, and communicated between the spool 30 and the device (e.g., target sub 22) via the cable 16. In certain instances, the spool 30 can communicate with an external device 36 at the terranean surface 20. In instances using a communications sub 60, the communications sub 60 is operated to communicate between the spool 30 and the external device 36.

As the well string 12 is extended deeper into the Earth (e.g., as the as the drill bit 24 drills deeper into the Earth), it is lengthened by adding joints of drill pipe and/or other components at the rig 18. The spool 30 travels deeper into the Earth with the string 12 and is periodically and/or continually raised to maintain the spool 30 proximate the surface 20, and if provided, proximate and in communication with the surface communication sub 60. The spool 30 can be raised using a lifting tool (e.g. lifting tool 316), or if the spool 30 is so configured, the spool 30 can be actuated to crawl uphole through the string 12 to maintain its position. As the spool 30 is raised, the segment of cable 16 carried by the spool 30 is paid off the spool 30 toward the device in a controlled manner. The spool 30 maintains tension on the cable preventing too much cable from being spooled off and reducing the likelihood of slacking and tangling. Communication of power and/or data is maintained with the spool 30, and in turn, is communicated from the spool 30 to the device via the cable 16.

As the segment of cable 16 carried by the spool 30 begins to run out or at another specified location in the well string 12, an interface sub 32 can be provided in the well string 12 for the spool 30 to dock into. Thereafter, a second spool 30 is supported in the well string 12 and its second cable 16 is coupled to the first spool 30. Communication of power and/or data is established between the first and second spools 30 via the second cable 16. The second spool 30 can communicate with the external device 36 at the terranean surface 20, for example, using the surface communications sub 60.

The power and/or data communicated between the terranean surface 20, the first and second spool 30, and the target sub 22 can be repeated and, in certain instances, conditioned (e.g., reformat, remove noise, amplify and/or other conditioning) by the spools 30 and/or interface subs 32.

As the first and second spools 30 travel deeper into the Earth with the string 12, the second spool 30 is periodically and/or continually raised to maintain the spool 30 proximate the surface 20. As the segment of second cable 16 carried by the second spool 30 begins to run out or at another specified location in the well string 12, a second interface sub 32 can be provided in the well string 12 for the second spool 30 to dock into. Thereafter, a third and subsequent spools 30 can be supported in the well string 12 and coupled to preceding spools 30 in the same manner as needed.

A number of embodiments have been described. Nevertheless, it will be understood that various modifications may be made. Accordingly, other embodiments are within the scope of the following claims.

What is claimed is:

1. A well system, the system comprising:
a first spool configured to be received in a well and carrying a first span of communication cable;
a second spool configured to be received in the well and carrying a second span of communication cable; and
a signal repeater communicably coupled between the first span of communication cable and the second span of communication cable.

2. The system of claim 1, where the signal repeater is carried by the first spool.

3. The system of claim 1, further comprising a well string and where the first and second spools are carried in a central bore of the well string, and
where the well string comprises an interface sub comprising the signal repeater.

4. The system of claim 3 further comprising a sensor carried by the interface sub for sensing an ambient characteristic in the well and where information from the sensor is communicated on one or more of the first or the second span of communication cable.

5. The system of claim 3, further comprising a gripper on the first spool configured to grip an internal profile of the interface sub and support the first spool relative to the well string.

6. The system of claim 1, further comprising:
a well string comprising a well tool; and
where the first span of communication cable is communicably coupled to the well tool and configured to pay out the first span of communication cable when an axial space between the first spool and the well tool is increased.

7. The system of claim 1, where the first span of communication cable comprises at least one of a power communicating cable or a data communicating cable.

8. The system of claim 1, where the signal repeater amplifies the signal from the first communication cable.

9. The system of claim 1, further comprising a sensor carried by the first spool for sensing an ambient characteristic in the well and where information from the sensor is communicated on one or more of the first or the second span of communication cable.

10. The system of claim 9, where the sensor comprises one or more of a pressure sensor, a temperature sensor, or a flow sensor.

11. The system of claim 1, further comprising a device between the first span of communication cable and the second span of communication cable, and responsive based on signal from one or more of the first span of communication cable or the second span of communication cable.

12. The system of claim 1, further comprising a power storage device carried by the first spool coupled to provide power to the signal repeater.

13. The system of claim 1, where the first spool further comprises a cable brake.

14. The system of claim 1, further comprising a surface communication sub configured to wirelessly communicate with the second spool.

15. The system of claim 1, further comprising a gripper on the first spool configured to grip a tubular surrounding the first spool and support the first spool relative to the tubular.

16. The system of claim 15, where the gripper comprises a slip.

17. The system of claim 1, where the cable comprises a fiber optic.

18. A method, comprising:
paying out a first span of communication cable from within a subterranean well to a device in a well string as the device moves with the well string downhole;
paying out a second span of communication cable from within a well to the first span of communication cable as the device and the first span moves with the well string downhole; and
receiving a signal from one of the spans of communication cable and relaying the signal to other of the spans of communication cable.

19. The method of claim 18, wherein the first span of communication cable comprises at least one of power or data communication cable.

20. The method of claim 18, further comprising, from a sub coupled to both the first and second spans of communication cable, sensing an ambient characteristic about the well string and communicating the characteristic on one or more of the first or second spans of communication cable.

21. The method of claim 18, further comprising actuating a device in a sub coupled to both the first and second spans of communication cable in response to a signal from one or more of the first and second spans communication cable.

22. The method of claim 18, further comprising communicating with the second span of communication cable from the terranean surface wirelessly.

23. The method of claim 18, activating a gripper to grip a tubular in the well at a non-profiled location in the tubular and support the second span of communication cable within the well.

24. A wellbore communication system, comprising:
a first downhole positionable cable bobbin;
a second downhole positionable cable bobbin; and
a relay that receives and repeats signals between cables of the first and second cable bobbins.

25. The wellbore communication system of claim 24, further comprising a sensor carried with the relay that communicates on the cables.

26. The wellbore communication system of claim 24, a device carried with the relay that is responsive to a signal communicated on the cables.

27. The wellbore communication system of claim 24, where the relay is carried by the first cable bobbin.

28. The wellbore communication system of claim 24, where the relay is carried by well string that receives the first and second cable bobbins in its central bore.
